(19) United States
(12) Patent Application Publication
(10) Pub. No.: US 2007/0288580 A1
(43) Pub. Date: Dec. 13, 2007

(54) Policy-Based Management of Instant Message Windows

(75) Inventors: David L. Kaminsky, Chapel Hill, NC (US); David M. Ogle, Cary, NC (US)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 11/770,488

(22) Filed: Jun. 28, 2007

Related U.S. Application Data
(63) Continuation of application No. 10/654,786, filed on Sep. 4, 2003.

(51) Int. Cl. G06F 15/173

(52) U.S. Cl. 709/206

(57) ABSTRACT

Techniques are disclosed for managing instant messages, including the display of windows for incoming messages, as well as for managing status information for instant messaging users. In one aspect, an instant messaging user defines policy information to programmatically determine a response to an arriving instant message. As an example, the policy may control whether a new window will pop up for a newly-arriving message, and may specify other attributes of the window if desired. In another aspect, an instant messaging user defines attributes pertaining to how his instant messaging status will be presented to others.

### RELATED INVENTION

The present invention is related to commonly-assigned, co-pending U.S. patent application Ser. No. 10/655,526, which is titled “Managing Status Information for Instant Messaging Users” and which was filed on Sep. 4, 2003 and is hereby incorporated herein by reference.

### BACKGROUND OF THE INVENTION

1. Field of the Invention

The present invention relates to computer software, and deals more particularly with techniques for managing instant messages, including the display of windows for incoming messages, as well as for managing status information for instant messaging users.

2. Description of the Related Art

Instant messaging systems are a popular communications mechanism for many people, and provide for instant, real-time communication between users who are connected to the system through an on-line or electronic networking environment such as the Internet, World Wide Web (hereinafter, “Web”), or corporate internal intranets. Examples of instant messaging systems include Yahoo!® Messenger, AOL Instant Messenger^{SM}, and Sametime®. (“Yahoo!” is a registered trademark of Yahoo! Inc., “AOL Instant Messenger” is a service mark of America Online, Inc., and “Sametime” is a registered trademark of Lotus Development Corporation.)

Instant messaging systems provide real-time awareness of who is logged on. Typically, an instant messaging (hereinafter, “IM”) system user has an address book containing names or nicknames (also referred to as “screen names”) for those people with whom he communicates. The entries in this address book can then be used for easily selecting a message recipient. The address book may be alternatively be referred to as a “buddy list”. An IM system (“IMS”) typically uses a visual cue (such as different icons or different fonts) to indicate which of the people in the address book are currently logged on to the system and which are not.

When the message sender and the target recipient are both logged on to an IMS (which may be the same IMS, or a different IMS), a message can be delivered and presented to the target recipient nearly instantly (depending, of course, on network delay). Instant messaging systems are well known in the art, and a detailed description thereof is not deemed necessary to an understanding of the present invention.

An IMS user may also have user groups defined in his address book, where a user group comprises individual users (each of whom may also have a separate entry in the address book) and, optionally, other groups.

Instant messaging systems are often used for communicating among friends, and are also becoming integral business tools that enable team members or business associates to communicate more efficiently and effectively (e.g., as they collaborate on a project).

As IM systems are increasingly adopted as a communications mechanism, it is becoming common for IM users to have multiple IM messages arriving in relatively quick succession, and as a result, a number of IM windows may pop up (i.e., open) on the user's display. See, for example, FIG. 1, which illustrates a common scenario wherein a user viewing a Web page 100 also has, on the same display surface, a buddy list window 110, a presence window 140 (showing the current IM status of several other IM users), and 3 IM windows 120, 130, 150. In these IM windows 120, 130, 150, dynamic IM message exchanges may be taking place; or, an inbound message may be displayed that has been received but which is not currently being addressed by the recipient.

As can be seen in this example, the proliferation of IM windows can lead to significant cluttering of the display surface. In addition, the IM window pop-up may occur at an inopportune time, which can be distracting to the recipient user. For example, the recipient might be working with the contents of another window that becomes (at least partially) overlaid by the new IM window. Or, the pop-up might simply interrupt the recipient's concentration. Furthermore, the IM window pop-up is often unexpected, and may cause embarrassment to the recipient. For example, an IM window might pop up with a personal message while the recipient is in the presence of others. Or, a window might pop up containing a non-business-related message while the recipient's manager is looking at the recipient's display device.

Senders of instant messages also have an expectation that a response will be forthcoming rapidly, since this is the nature of the communications, unless the recipient has configured his IM client to indicate otherwise. For example, instant messaging systems such as AOL Instant Messenger and Lotus Sametime Connect allow a user to change his IM status at a point in time. Sametime has 3 states: “I am active”, “I am away”, and “Do not disturb me”. (A user is also allowed to specify a status message to be displayed to other IM users when he is in any of the 3 states.) An IM user may have enabled the “I am away” feature (referred to equivalently herein as the “away” feature) of his IM client, which allows other IM users monitoring his online presence to be informed (usually by a visual cue, as noted earlier) that this person is not currently available.

Using the “away” feature is one way to reduce the number of IM windows that will subsequently pop up for a particular user, although this approach is not terribly effective. That is, an IM user can change his status to “away” in hopes that other IM users will notice the visual cue on their own display and refrain from sending instant messages to the user who is away. Notably, however, the “away” status does not suppress the recipient's instant messages. Instead, the message sender sends the message, an IM window pops up and displays that message at the recipient, and the sender's IM window for this recipient then typically closes down. (This is in contrast to the procedure used for an active user, where the sender's IM window typically stays open to await a response IM.)

A more severe way to reduce the number of IM windows that will pop up is for a user to set his IM status to “do not disturb”. Prior art IMSs typically prevent messages from being sent to users having this status. (A request for an IM user's status may be automatically requested by the IMS, and therefore updated status information is available to the sender's IMS that influences whether the sender is allowed to send an instant message to another user.) This all-or-nothing approach is obviously not an optimal solution.

E-mail systems typically provide an “away” feature, as well as user-definable filtering capability. When an e-mail user configures his e-mail client to notify message senders that he is away, this provides a type of limited feedback to the sender, notifying him that an urgent message will not likely be acted upon with urgency, for example. (However, such “away” notification features are often misused, causing them to convey incorrect or out-of-date information.) Filtering capabilities in e-mail systems typically allow a user to define various keywords or other criteria, and special handling to be applied to inbound messages meeting those criteria. For example, messages containing vulgar words in their subject line may be automatically routed to a trash folder or trash mailbox by defining an appropriate filter.

Accordingly, what is needed are improved techniques for managing incoming messages when using instant messaging, and improved techniques for managing status information for instant messaging users.

### SUMMARY OF THE INVENTION

An object of the present invention is to provide improved techniques for managing incoming messages when using instant messaging.

A further object of the present invention is to enable instant messaging users to specify policy that automatically controls responses to inbound instant messages.

Still another object of the present invention is to use policy to determine whether a new window should be opened for an arriving instant message.

Another object of the present invention is to provide improved techniques for managing status information for instant messaging users.

A further object of the present invention is to provide techniques for enabling IMS users to define status levels, and related information for those levels, beyond what is provided by prior art IMSs.

Another object of the present invention is to assist IMS users in controlling the proliferation of IM windows that pop up on their display surface.

Yet another object of the present invention is to provide IMS users with enhanced status information about other IMS users.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention may be provided as methods, systems, and/or computer program products. In one aspect, the present invention provides techniques for enabling an IM user to specify policy information usable in responding to arrival of instant messages, further comprising: defining, by the IM user, policy information specifying criteria for responding to arrival of instant messages; and using the defined policy information, upon arrival of an instant message from an IM sender not already participating in an IM session with the IM user, to programmatically determine a response to the arriving instant message.

The policy information may identify, by way of illustration but not of limitation, one or more of the following: a particular IM sender, characteristics of IM senders, static criteria and/or dynamic criteria, a list of selected applications that may be active for the IM user, and/or specified types of entries that may be scheduled on the IM user's electronic calendar.

The policy information may be specified as a set of rules containing the criteria for opening a new IM window for incoming instant messages. The programmatically determined response may be to open a new IM window for the arriving instant message. The rules/policy may specify one or more attributes of the IM window to be opened. Examples of these attributes include whether the IM window to be opened is to be opened in a minimized state and whether the new IM window to be opened should flash when rendered. Or, the policy might specify that an indicator of the arriving instant message is to be displayed in a particular IM window that provides a visual indicator of availability of one or more instant messages (and, optionally, from which the IM user can selectively view any of the one or more instant messages).

Other types of responses that may be specified by the policy include generating an audible indicator to signal the arrival of the instant message. For example, the indicator might be generated only if the policy indicates that a new IM window is not to be opened for displaying the arriving instant message.

In another aspect, the present invention provides techniques for selectively opening IM windows, comprising: receiving an inbound instant message for a recipient IM user; and using policy information to programmatically determine whether a new IM window should be opened for the received instant message, if an IM session is not already established between the recipient IM user and a sending IM user who sent the received instant message. An indicator, which may be visual or audible, may be provided to the recipient IM user to notify the user that the instant message was received when the policy information indicates not to open the new IM window.

The present invention may also be used advantageously in methods of doing business, for example by providing improved IMS features for users or an improved IMS service for subscribers. In one aspect, this comprises providing techniques for controlling proliferation of IM windows by enabling a plurality of IM users to define criteria under which new IM windows should be opened responsive to receiving an instant message from message senders with whom an IM session is not already established; using the defined criteria to determine, for at least one of the IM users, whether a new IM window should be opened; and charging a fee for carrying out either or both of the enabling and using operations. The fee for these improved features or the improved service may be collected under various revenue models, such as pay-per-use billing, monthly or other periodic billing, and so forth.

The present invention will now be described with reference to the following drawings, in which like reference numbers denote the same element throughout.

### BRIEF DESCRIPTION OF THE DRAWINGS

FIG. 1 provides a sample graphical user interface (“GUI”) display of an IM system, showing multiple IM windows arranged on a user's display surface, according to the prior art;

FIG. 2 illustrates a sample GUI display where IM window pop-up has been suppressed, yet arrival of new message text is graphically indicated to the recipient, according to the present invention;

FIG. 3 illustrates an alternative way to represent the information in FIG. 2;

FIG. 4 provides a sample configuration menu whereby an IM user can choose his current IM status, according to the present invention; and

FIGS. 5 and 6 provide sample rules that may be used, at run-time, by embodiments of the present invention.

### DESCRIPTION OF PREFERRED EMBODIMENTS

The present invention provides techniques for managing arrival of incoming messages when using instant messaging, as well as for managing status information for instant messaging users. As will be described in more detail herein, the present invention provides an improved interface paradigm by IMS users as well as a finer-grained mechanism for specifying user status. In other words, IMS users have more control over what they see, and what others see about them. Using the disclosed techniques, an IMS provides its users with more productive and/or enjoyable ways to communicate and to exchange messages.

According to a first aspect of the present invention, an IMS user defines classification information, also referred to herein as policy information, that determines how the IM user's client should respond to newly-arriving instant messages. As an example, the policy may specify conditions under which new IM windows will pop up on that user's display surface. The policy may also specify various attributes related to the IM windows, such as whether they pop up in normal size or are presented as an icon representing a minimized window, etc.

In a second aspect, the present invention enables an IMS user to define status information that will be provided to other IMS users, where this status information augments or extends the rather limited information provided by existing IMSs. (This status information may also be considered “policy”, although that term is not used in discussions herein to avoid confusion with the first aspect.)

These aspects will now be described in more detail.

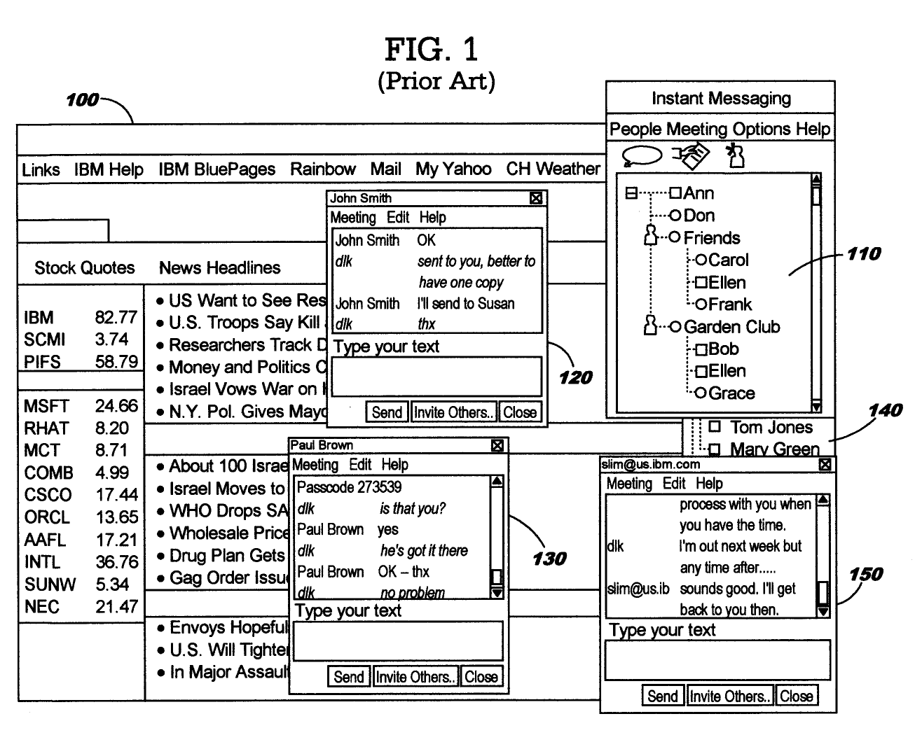

With reference to the first aspect of the present invention, prior art messaging systems do not allow a recipient of an instant message to indicate that some messages are important to this recipient while others are not. Instead, incoming instant messages cause a new IM window to pop up each time an IM from a distinct user arrives, as has been briefly discussed above (and as has been illustrated in FIG. 1), unless the recipient has all inbound messages blocked. (Messages arriving from senders who already have an IM session with the recipient are typically displayed in an existing IM window for that session, and thus such messages do not further contribute to the proliferation of open windows.) Using techniques of the present invention, on the other hand, the IMS user can configure his system to programmatically respond to an arriving instant message, such as by selectively popping up new windows. For example, an IMS user might define a policy that pops up a new IM window if the sender is an executive or someone in the recipient's management chain, while messages received from team members have an entry in the task bar (with the corresponding window being minimized), and so forth. These are examples of static types of criteria. Alternatively, policy may be expressed using dynamic criteria (or a combination of static and dynamic criteria). As examples of using dynamic criteria, the user might define a policy that pops up a new IM window for arriving instant messages except when one of a list of selected applications is currently active on the recipient's computing device, or that pops up a new IM window unless specified types of entries are scheduled on the recipient's electronic calendar. (Preferably, policy information is defined in a manner that enables specification of criteria using both positive and negative connotations, such as “pop up a window if . . . ” and “pop up a window unless . . . ”, as exemplified by these examples.)

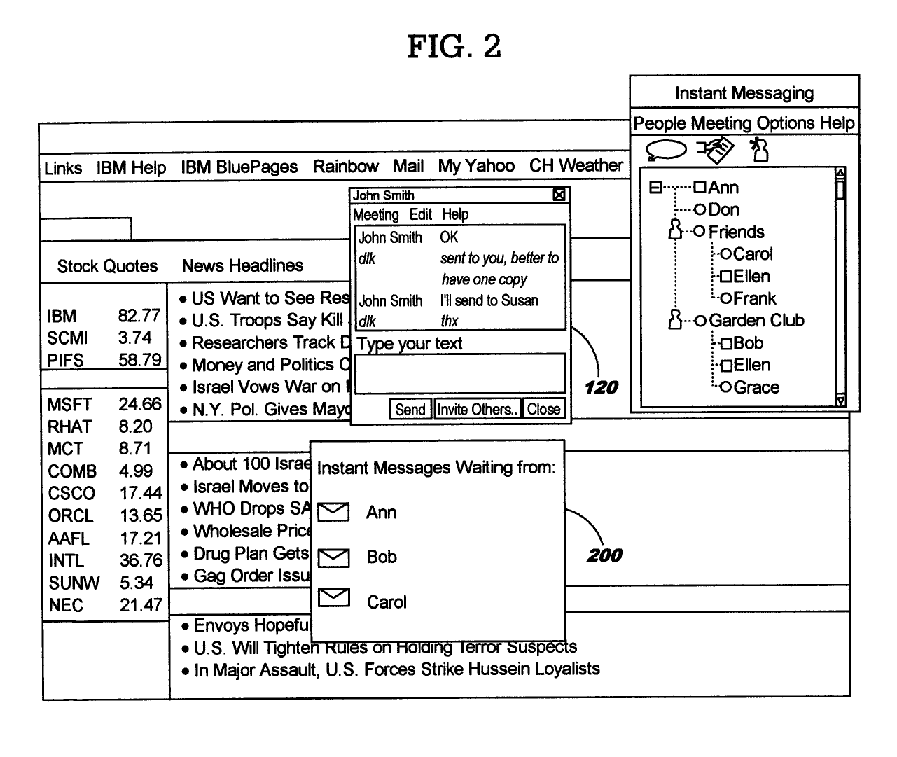

As another example of using policy to programmatically respond to an arriving instant message, policy information may specify that selected IM windows are to be sent to a distinct folder or that selected instant messages are to be sent to a particular window, whereby an indication of the message sender (e.g., the sender's nickname or e-mail address) is provided, but the message text is suppressed unless the recipient explicitly requests its display. This provides a consolidation of windows, addressing the prior art problems of visual clutter as well as the potential embarrassment or distraction experienced by prior art IMS users when a window pops up for each inbound IM. This is illustrated at element 200 in FIG. 2.

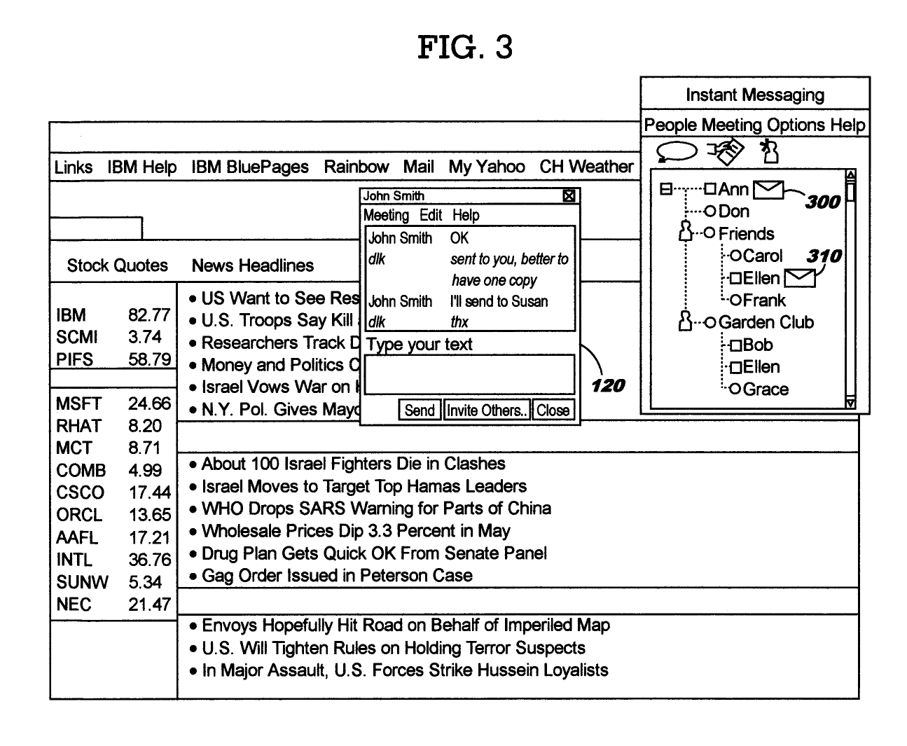

As an alternative to using a separate folder or window for indicating that IM text is available upon request but not currently displayed, a visual indicator that IM message text is available for on-request display may be provided within an already-displayed buddy list or status window. This is illustrated at elements 300, 310 in FIG. 3.

Policy information according to this first aspect may also be used to control attributes of an IM window. For example, an IM window from a selected sender might be displayed with a flashing border, or with a border or background of a certain color, and so forth. As another example, a beeping sound or similar alarm-type function might be triggered when an IM window is created for a particular sender.

The techniques illustrated in FIGS. 2 and 3 are applied to messages according to an IM user's policy, as stated above. The degree to which this suppresses the pop-up of new IM windows depends on the criteria specified in the policy. For example, if an IM user wishes to suppress all IM window pop-ups, he may define a policy using wildcards for the various criteria. As a result, incoming instant messages are received at the user's IM client and await his on-demand retrieval, but the IM user will not be disturbed by new IM window pop-ups. (This is in contrast to the prior art approach, whereby a “do not disturb” IM status prevents new IM windows from being displayed but also prevents any IM text from being received.)

With reference to the second aspect of the present invention, prior art IMSs are typically limited to 3 predefined types or levels of IM user status—namely, “active”, “away”, and “do not disturb”. The present invention enables IM users to define one or more additional status levels. This status information can then be made available to other IMS users, providing them with finer-grained information.

As an example, an IMS user “Joe” might be actively using the device on which his IM client runs, but might be temporarily involved in some activity that will prevent him from responding immediately to incoming instant messages. Thus, Joe may use techniques disclosed herein to define an IM status such as “temporarily distracted”. A user who sends an IM to Joe therefore knows not to expect an immediate response (in contrast to the sender's expectation when sending a message to an IM user with status “available”), yet the sender's IM client will preferably leave the sending window open for an eventual response (in contrast to the automatic closing of the sending window after a message is sent to an IM user with status “away”).

Optionally, an IM user who defines additional status levels may be allowed to specify attributes to be associated with those levels. For example, if green is used when presenting an icon for active IM users as a visual indication that a speedy response may be expected, then Joe might specify that yellow should be used for his icon when he is in the “temporarily distracted” state, thereby efficiently conveying to other IM users that his messages may be delayed.

When selecting a color, a menu of choices may be presented. For example, Joe might be presented with a configuration panel having radio buttons with which a choice can be made from a collection of available colors. Or, Joe might be allowed to specify a particular icon to be associated with his user-defined status level, for instance by specifying a Uniform Resource Locator (“URL”) or similar address where an image file is located.

In addition to or instead of defining a color attribute for a user-defined status level, Joe may be allowed to define one or more other attributes that include—but are not limited to—a status label and display text for the status. As example status label is “distracted”, for the “temporarily distracted” status, and an example display text for that status is “I am distracted at the moment, but I'll reply to messages soon.”.

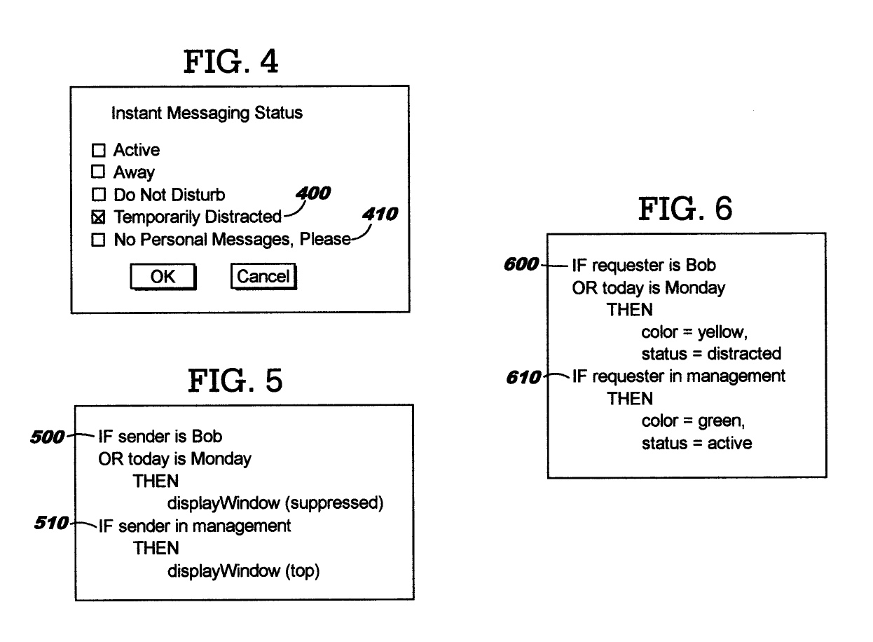

Preferably, a user explicitly indicates that a particular user-defined IM status level is now applicable to him. For example, a menu might be provided whereby Joe can click a graphical button to indicate that he is now in the “temporarily distracted” status. This is illustrated in FIG. 4, where two user-defined IM status levels are shown at 400, 410. (The sample status level 410 might be used, for example, by an employee during working hours. When other IM users see that this is the user's current status, according to embodiments of the present invention, they preferably tailor their message content accordingly. In addition or instead, the employee may define criteria for suppressing pop-up of IM windows for inbound instant messages containing certain keywords or having other indicators of “personal” message content.)

The user-defined IM status level information is preferably stored in a database or other repository that is accessible to the IMS(s) of other IM users, and is preferably stored in association with the user's nickname. In this manner, a look-up operation can be performed to determine how this user's current IM status should be represented. In current IM systems, an IM server determines the IM status, or “presence”, of the other users and groups defined in an address book. For example, if Joe has 15 people defined in his address book, then Joe's IM server dynamically determines the IM status of these 15 users and updates Joe's IM display to indicate which of the users are currently online (and are therefore available for participating in an IM session). Existing IMSs are configured to operate with predefined status levels, as stated earlier, and present a visual depiction of status accordingly. If Joe's current status is one of his user-defined status levels, according to the present invention, then the IM server preferably consults the data repository where Joe's specified choices for attributes are stored and uses the information stored therein when depicting Joe's status on the IM display of other IM users.

Preferably, the repository of user-defined status level information is access-controlled to ensure that only the user whose information is stored therein is allowed to make changes. For example, the user may be required to provide a user identifier (“ID”) and password before update operations can be performed on the data.

Optionally, the user's selection of his current IM status level may be stored in this repository. Alternatively, the existing presence function may be adapted such that a user-defined IM status level is dynamically determined as an option to one of the predefined status levels.

As an alternative to storing status information in a repository and accessing that repository by other IMSs, an IM user's status may be distributed to other IM clients using a message exchange. For example, a markup language such as the Extensible Markup Language (“XML”) may be used to encode status information in a message and periodically distribute that information (for example, when a status change occurs). Such messages may include, by way of example, the user's current status, display text associated with that status, a color and/or the URL of an icon associated with that status, and so forth.

User-defined status levels may be used to control responses to arriving instant messages (such as the pop-up of new IM windows), in addition to indicating how the IM user should be represented to other IM users, by encoding the status level as a criterion in rules specified in the user's policy. Alternatively, these two aspects may be used separately. The manner in which rules are defined for controlling responses to arriving instant messages and for status display, according to preferred embodiments, will now be described.

Rules are preferably expressed in an “IF THEN” form, and may be processed by a rules engine or other conditional process evaluating component. A set of rules governing the pop-up of windows is illustrated in FIG. 5, using a sample syntax for illustrative purposes. As shown therein, a first rule 500 specifies that if an instant message is received from the user “Bob”, or is received on a Monday, then the window pop-up is to be suppressed. (Instead, an indication of a waiting message may be depicted using a technique such as those illustrated at element 200 of FIG. 2 or elements 300, 310 of FIG. 3.) A second rule 510 specifies that if the sender of a newly-received instant message is in the recipient's management chain (or in a management classification), then an IM window for this message should be rendered at the top level of the display screen.

A variety of information may be specified in the “IF” part of a rule, as well as in the “THEN” part of a rule. The conditions tested in the “IF” part may be based on static and/or dynamic properties, and the examples provided herein are by way of illustration but not of limitation. In addition to conditions involving who the message sender is and the current day, as in rules 500, 510, conditions might test factors such as what the recipient is currently doing (which may be specified in terms of the active applications on the recipient's computing device and/or what entries are scheduled on the recipient's electronic calendar, for example). The “THEN” part of a rule is preferably expressed in terms of standard window properties, which can then be enforced by the windowing interface.

Certain classification information pertaining to message senders, such as whether a message sender is in the recipient's buddy list (not illustrated in rules 500, 510) can be determined using information available to the IMS. Other classification, such as whether the sender is in the recipient's management chain, is in the recipient's department, is an executive, is currently scheduled to attend the same meeting as the message recipient, and so forth may be determined by consulting a directory or other repository of information. Or, in some cases, multiple sources may be consulted. For example, electronic calendaring information may be consulted to determine whether the sender and recipient are scheduled to attend a particular meeting, and a compound “IF” statement in a rule might specify other conditions such as “in my management chain” that necessitate accessing a corporate organization chart repository.

Note that the message sender is not necessarily a human. In some cases, an automated process (commonly referred to as a “bot”) is a participant in IM sessions. This automated process may generate message content, and thus discussions herein of message senders and recipients should be construed as including automated processes as well as human users.

Examples of rules that may be specified for status display are illustrated in FIG. 6. This example has been designed, for purposes of illustration, as a counterpart to the rules shown in FIG. 5. Rule 600 specifies that, if the rule is being evaluated to present Joe's status to the IM user with nickname “Bob” or is being evaluated on a Monday, then Joe's status should be represented using the color yellow and should be shown as “distracted”. Rule 610 specifies that, if the rule is being evaluated to present Joe's status to an IM user in Joe's management chain, then the color green should be used in that representation and the status should be shown as “active”. Accordingly, Bob will be aware that he should not receive an immediate response from Joe (i.e., by interpreting the yellow color and “distracted” status), according to rule 600. Therefore, when Bob sends a message to Joe and that message is suppressed on Joe's display (according to rule 500), a delay in Joe noticing this message and/or sending a response will be within the expectations of the parties.

Similarly, if message senders in Joe's management chain have their IM windows displayed on the top of Joe's display surface, according to rule 510, then they may reasonably expect to receive a prompt response, in accordance with an IM user whose status is “active”, according to rule 610.

Other types of conditions may be tested in the status display rules, and other types of results may follow in the rule conclusions, and thus the rules in FIG. 6 (as well as the rules in FIG. 5) are to be considered as exemplary but not limiting. The status display rules are preferably stored in a data repository where they can be accessed by the IMS(s) of other IM users. The rules pertaining to responses to arriving instant messages are preferably stored in a local repository that is accessible by the user's IM client (or, equivalently, a rules engine or other conditional processing component operating on behalf of the client). Or, these two types of rules may be co-located. It should be noted that policy information is not required to be expressed in rules format, and thus references herein to rules are by way of example. Alternatives include specifying information in tables or collections of values against which comparisons are made.

At run-time, an inbound message for an IM user who has defined a policy (expressed, for example, in rules such as those shown in FIG. 5) triggers evaluation of the policy/rules information. For example, if Joe receives a message, his IM client preferably consults a local policy/rules repository to determine how to respond to that message (for example, whether the message should be displayed and if so, whether a new IM window should be popped up or whether an indication should be displayed in an already-opened window). And, if another IM user “Jill” has Joe in her buddy list, then Joe's current IM status on Jill's IM display can be refreshed by consulting Joe's status display rules.

As has been demonstrated, the present invention provides significant advantages over prior art IM systems, which limit an IM user's status information to predefined levels and which do not allow an IM user to selectively control how to respond to arriving instant messages (and in particular, do not allow the user to selectively control whether, or when, new IM windows pop up). The techniques disclosed herein are easy for the IM user to understand, configure, and use.

It should be noted that while preferred embodiments are described with reference to an IM system's “address book”, this term is used as a shorthand reference to any data structure or structures with which an IM client is able to remember the users and/or user groups with which it has engaged, or will engage, in instant messaging.

Commonly-assigned, co-pending U.S. patent application Ser. No. 10/235,324 (attorney docket RSW920020085US1, filed Sep. 5, 2002), titled “Annotating and Routing Message Content”, discloses techniques whereby programmatic determinations are made for routing instant messages. For example, user preferences may be consulted to determine whether a particular user approves of routing messages from a current IM session to other parties. The disclosed techniques may use a rule-based approach, if desired, to provide further controls over this programmatic determination (e.g., allowing factors such as the identification of the IM session partner, and perhaps keywords from the message and/or annotation, to be used when making the determination). Or, a partner in the IM session might be queried to determine whether routing the annotated message is acceptable.

Commonly-assigned, co-pending U.S. patent application Ser. No. 10/119,519 (attorney docket RSW920010234US1, filed Apr. 10, 2002; now U.S. Pat. No. 6,731,323), titled “Media-Enhanced Greetings and/or Responses in Communication Systems”, discloses using information regarding a message initiator (or a caller, in a voice mail system) and other sources of state information about the intended message recipient (or called party), in addition to information stored in an electronic calendar, when selecting media file(s) to be included in a programmatically-generated response message (or greeting for a voice caller). For example, suppose a user Sam has his instant messaging buddy list arranged into categories including “friends” and “customers”. Using techniques of this commonly-assigned invention, Sam may specify that when his electronic calendar shows an “I'm sick” status, instant messaging participants identified in the “friends” category receive a “bio-hazard” icon in response to sending him an instant message while participants identified in the “customers” category receive an “out of office” icon. The icon might be attached to a text message that is generated as a response to the original message sender, or the icon might be sent without an accompanying message. In either case, this commonly-assigned invention allows IMS users to add personalization to a message that is automatically sent to people attempting to contact the user.

This commonly-assigned invention also discloses enabling an IM user to hover the cursor of his computing device over an identifier of someone on his buddy list, whereby an icon corresponding to that person's current status may then be displayed for the hover message. This commonly-assigned invention also discloses enabling IM users to manually trigger the sending of status information to other IM users. For example, an IM session participant may be at work, and may choose to suspend an IM session when his manager enters his office. The participant might indicate this to the other session participant by clicking on an icon or menu item (or some other mechanism) that would cause an icon (e.g., a stop sign) to be sent to the other session participant. This may optionally cause the IM session to be temporarily suspended. Additionally, the IMS may prevent the IM session from continuing (for example, by automatically closing the IM session window).

Commonly-assigned, co-pending U.S. patent application Ser. No. 09/941,045 (now U.S. Pat. No. 7,035,865), titled “Calendar-Enhanced Awareness for Instant Messaging Systems and Electronic Status Boards”, discloses techniques for automating a user's instant messaging status, based on information stored in the user's electronic calendaring system. Additionally, this commonly-assigned invention discloses enhancements to an advanced calendaring system whereby instant messaging systems (and electronic status boards) are preemptively notified of status changes for a defined set of users. A retry/recovery technique is disclosed, which may be used (for example) if updated information is expected but not received.

The techniques disclosed herein may be used advantageously in methods of doing business, for example by providing services whereby IMS users can define criteria under which new IM windows should be opened responsive to receiving an instant message from message senders with whom an IM session is not already established; using the defined criteria to determine, upon receiving an instant message from at least one of the IM users, whether a new IM window should be opened; and charging a fee for carrying out these operations, as has been described. This service may be provided under various revenue models, such as pay-per-use billing, monthly or other periodic billing, and so forth.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-readable storage media (including, but not limited to, disk storage, CD-ROM, optical storage, and so forth) having computer-readable program code or instructions embodied therein.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

What is claimed is:

1. A method of using policy information to respond to arrival of instant messages at an instant messaging (“IM”) client, comprising:
receiving an arriving instant message at an IM client; and
responsive to the receiving, determining, by the IM client, whether an IM session already exists between the IM client and another IM client from which the received instant message is received and if so, displaying the received instant message in an already-opened IM window used for the existing IM session and if not, determining whether a new IM window should be opened at the IM client for the received instant message, further comprising:
consulting, by the IM client, stored policy information applicable to a user of the IM client to locate rules for responding to arrival of instant messages; and
opening the new IM window and displaying the received instant message therein if the located rules indicate that the new IM window should be opened for the received instant message, and otherwise, suppressing the opening of the new IM window and providing an indicator to notify the user of the IM client that the received instant message has been received.

2. The method according to claim 1, wherein:
the policy information identifies at least one particular IM sender; and
the suppressing occurs only if an IM sender from whom the received instant message is received is one of the identified at least one particular IM senders.

3. The method according to claim 1, wherein the policy information identifies characteristics of IM senders.

4. The method according to claim 1, wherein the policy information specifies static criteria.

5. The method according to claim 1, wherein the policy information specifies dynamic criteria.

6. The method according to claim 1, wherein the consulting further comprises using an identifier of the IM sender from whom the received instant message is received and locating any of the rules which are applicable to instant messages received from this IM sender.

7. The method according to claim 1, wherein the rules further specify at least one attribute of the new IM window to be opened.

8. The method according to claim 7, wherein one of the at least one attributes comprises one of: whether the new IM window to be opened is to be opened in a minimized state; and whether the new IM window flashes when rendered.

9. The method according to claim 1, wherein the indicator comprises an audible indicator.

10. The method according to claim 1, wherein the indicator comprises a visual indicator.

11. The method according to claim 10, wherein the visual indicator is operable to enable the user of the IM client to selectively view the received instant message.

12. The method according to claim 1, wherein the policy information identifies a list of selected applications, other than the IM client, that are executable on a computing device of the IM user.

13. The method according to claim 1, wherein the policy information identifies specified types of entries that may be scheduled on an electronic calendar of the user of the IM client.

14. A computer program product for using policy information to respond to arrival of instant messages at an instant messaging (“IM”) client, the computer program product embodied on one or more computer-readable storage media and comprising:
computer-readable program code for receiving an arriving instant message at an IM client; and
computer-readable program code for responding to the receiving by determining, by the IM client, whether an IM session already exists between the IM client and another IM client from which the received instant message is received and if so, displaying the received instant message in an already-opened IM window used for the existing IM session and if not, determining whether a new IM window should be opened at the IM client for the received instant message, further comprising:
computer-readable program code for consulting, by the IM client, stored policy information applicable to the user of the IM client to locate rules for responding to arrival of instant messages; and
computer-readable program code for opening the new IM window and displaying the received instant message therein if the located rules indicate that the new IM window should be opened for the received instant message, and otherwise, suppressing the opening of the new IM window and providing an indicator to notify a user of the IM client that the received instant message has been received.

15. A method of providing user-defined status information in an instant messaging (“IM”) system, comprising:
receiving an indication, by an IM client from a user of the IM client, that a particular IM status defined by the user is now applicable to the user;
storing, responsive to the receiving, the particular IM status in a repository that is accessible to other IM client users for determining, by the other IM client users, a currently-applicable IM status of the user of the IM client; and
responsive to queries of the repository by any of the other IM clients, providing the stored particular IM status as the currently-applicable IM status of the user of the IM client.

16. A method of providing user-defined status information in an instant messaging (“IM”) system, comprising:
receiving an indication, by an IM client from a user of the IM client, that a particular IM status defined by the user is now applicable to the user; and
sending the particular IM status from the IM client to other IM clients with which the IM client communicates using the IM system, for use by each selected one of the other IM clients in providing an indication, for the selected one of the other IM clients, of a currently-applicable IM status of the user of the IM client.

17. The method according to claim 16, further comprising:
receiving an arriving instant message at the IM client from a particular one of the other IM clients; and
responsive to the receiving, determining, by the IM client, whether an IM session already exists between the IM client and the particular one of the other IM clients and if so, displaying the received instant message in an already-opened IM window used for the existing IM session and if not, determining whether a new IM window should be opened at the IM client for the received instant message, further comprising:
consulting, by the IM client, stored policy information applicable to the user of the IM client to locate rules for responding to received instant messages; and
opening the new IM window and displaying the received instant message therein if the located rules indicate that the new IM window should be opened for the received instant message, and otherwise, suppressing the opening of the new IM window and providing an indicator to notify the user of the IM client that the received instant message has been received.

18. The method according to claim 16, wherein the sending further comprises sending at least one attribute associated with the currently-applicable IM status of the user.

19. The method according to claim 18, wherein the at least one attribute comprises at least one of: a color to be used in the provided indication for the currently-applicable IM status of the user; a text message to be used in the provided indication for the currently-applicable IM status of the user; or a status label to be used in the provided indication for the currently-applicable IM status of the user.

20. The method according to claim 16, wherein the sending further comprises sending the particular IM status using markup language syntax.
